(19) United States
(12) Patent Application Publication
(10) Pub. No.: US 2014/0062234 A1
(43) Pub. Date: Mar. 6, 2014

(54) ROTATING ELECTRICAL MACHINE

(71) Applicant: Honda Motor Co., Ltd., Tokyo (JP)

(72) Inventor: Sayaka TAMURA, Wako (JP)

(73) Assignee: Honda Motor Co., Ltd., Tokyo (JP)

(21) Appl. No.: 14/014,357

(22) Filed: Aug. 30, 2013

(30) Foreign Application Priority Data
Aug. 31, 2012 (JP) 2012-192617

(51) Int. Cl. H02K 5/22

(52) U.S. Cl. CPC H02K 5/225
USPC 310/71

(57) ABSTRACT

A rotating electrical machine includes a stator, a housing, a first connection terminal, a terminal board, and a fastening member. The terminal board includes a body and a relay conductor to which the first connection terminal and a second connection terminal are connected. The relay conductor is provided in the body. The second connection terminal is connected to an external power line. The first connection terminal is connected to the relay conductor with the fastening member is screwed into an end portion of the relay conductor. The relay conductor is provided, under screwing action of the fastening member, to be moved toward the first connection terminal to be held in the body.

### CROSS-REFERENCE TO RELATED APPLICATIONS

The present application claims priority under 35 U.S.C. §119 to Japanese Patent Application No. 2012-192617, filed Aug. 31, 2012, entitled “Rotating Electrical Machine.” The contents of this application are incorporated herein by reference in their entirety.

### BACKGROUND OF THE INVENTION

1. Field of the Invention

The present disclosure relates to a rotating electrical machine.

2. Discussion of the Background

Rotating electrical machines (e.g., motors) have been known in which a plurality of coils wound in slots of a stator produce a rotating magnetic field to rotate a rotor in the center of the stator. Such a rotating electrical machine has three-phase feeder lines for supplying power to conductor lines, such as coils, and a terminal board for connection between the feeder lines and a power supply. For example, the terminal board is secured with bolts to a housing that contains a stator and a rotor. The terminal board includes three busbars that correspond to the respective feeder lines, and a cover that covers the busbars. Terminals connected to the feeder lines are connected to respective one ends of the busbars made of a conductive material, and terminals of cables connected to the power supply are connected to the respective other ends of the busbars. The busbars are formed such that the one ends and the other ends thereof are orthogonal to each other (see, e.g., Japanese Unexamined Patent Application Publication No. 2004-327184).

### SUMMARY OF THE INVENTION

According to one aspect of the present invention, a rotating electrical machine includes a stator, a housing, a first connection terminal, a terminal board, and a fastening member. The stator has a conductor line wound thereon. The housing is to contain the stator. The first connection terminal is connected to the conductor line. The terminal board is to make an electrical connection between the conductor line and an external power line which is disposed outside the housing and which is connected to a power supply. The terminal board includes a body and a relay conductor to which the first connection terminal and a second connection terminal are connected. The relay conductor is provided in the body. The second connection terminal is connected to the external power line. The first connection terminal is connected to the relay conductor with the fastening member is screwed into an end portion of the relay conductor. The relay conductor is provided, under screwing action of the fastening member, to be moved toward the first connection terminal to be held in the body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an external front view of a rotating electrical machine according to an embodiment of the present disclosure, the rotating electrical machine being contained in a motor case.

FIG. 2 is a cross-sectional view taken along line II-II of FIG. 1.

FIG. 3 is an exploded perspective view illustrating motor terminals removed from a body of a terminal board included in the rotating electrical machine of FIG. 1.

FIG. 4 is an exploded perspective view illustrating bus rods removed from the body of the terminal board of FIG. 1.

FIG. 5 is an enlarged cross-sectional view of part of FIG. 2, the view illustrating an area where a bus rod and a collar are in contact with each other.

FIG. 6 is a cross-sectional view taken along line VI-VI of FIG. 5.

FIG. 7 is an exploded perspective view illustrating a terminal cover removed from a motor case of FIG. 1, and second terminal bolts removed from the bus rods.

### DESCRIPTION OF THE EMBODIMENTS

The embodiments will now be described with reference to the accompanying drawings, wherein like reference numerals designate corresponding or identical elements throughout the various drawings.

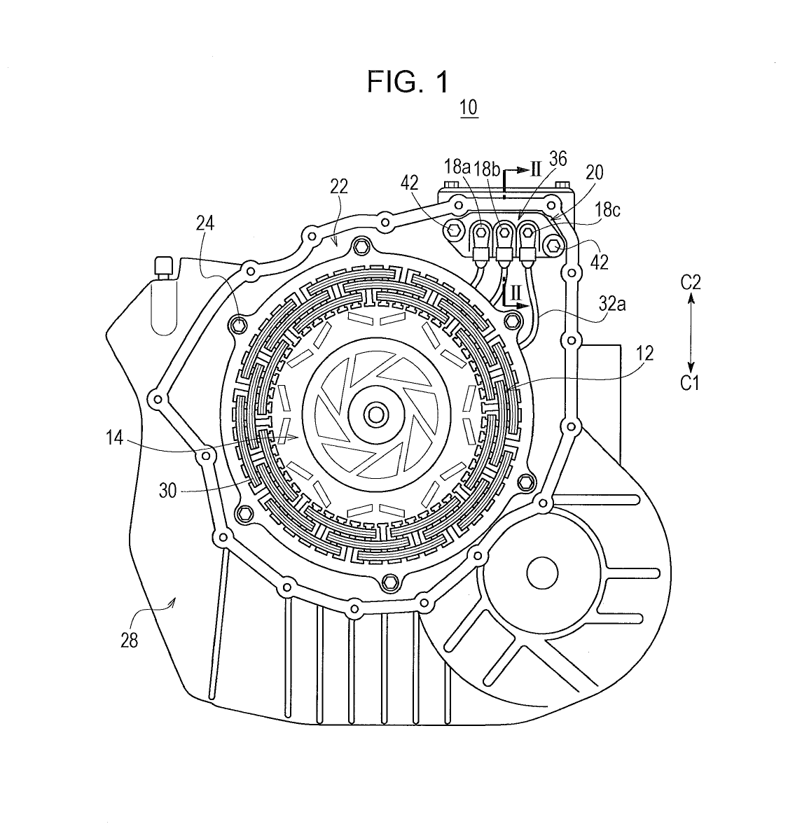

In FIG. 1, reference numeral 10 denotes a rotating electrical machine according to an embodiment of the present disclosure.

For example, the rotating electrical machine 10 is a three-phase alternating current brushless motor. As illustrated in FIG. 1, the rotating electrical machine 10 includes an annular stator 12, a rotor 14 inserted in the center of the stator 12, and a terminal board 20 that makes a connection between three-phase motor terminals (first connection terminals) 18a to 18c and a power supply (not shown). The rotating electrical machine 10 drives the rotor 14 to rotate on the basis of power supplied from the power supply (not shown) through the motor terminals 18a to 18c.

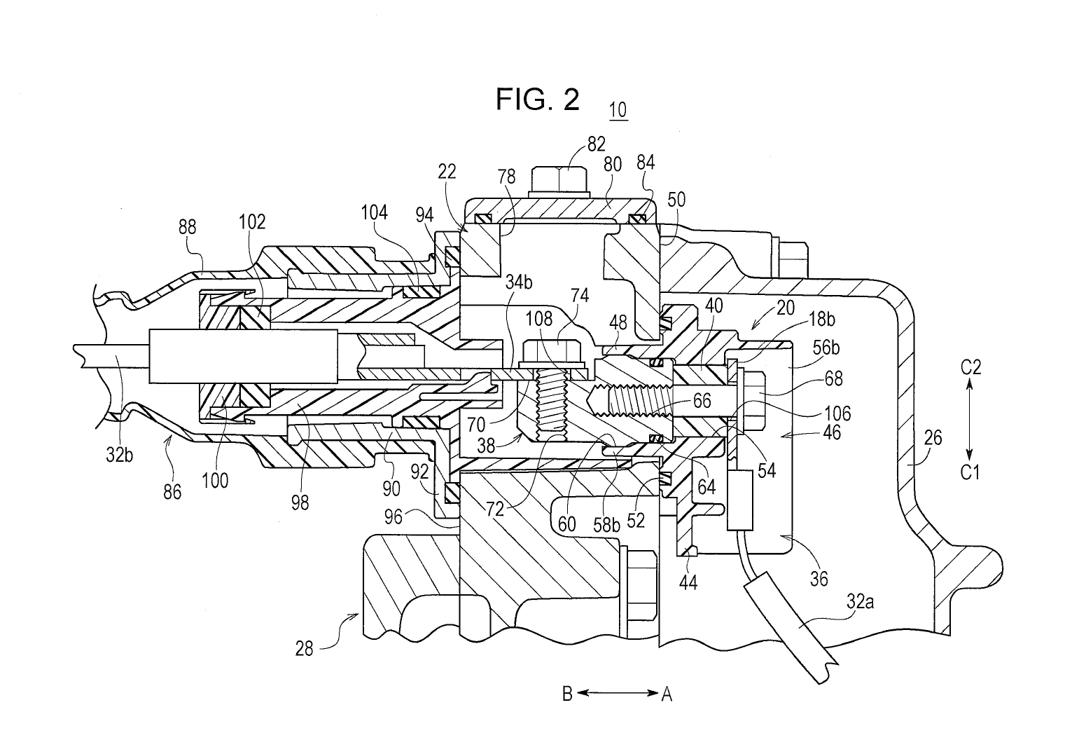

The rotating electrical machine 10 is contained in an annular motor case (case) 22, to which the stator 12 is secured with bolts 24. At the same time, as illustrated in FIG. 2, a motor case cover 26 is attached to one end of the motor case 22, and a transmission case 28 containing a transmission mechanism for a vehicle is connected to the other end of the motor case 22. The internal structure of the motor case 22 is thus obtained.

For example, the stator 12 is formed by a plurality of steel plates that are stacked and connected together in the axial direction and integrally held by caulking or welding. A plurality of coils (conductor lines) 30 are mounted in slots of the stator 12 and connected to the three-phase motor terminals 18a to 18c.

The motor case 22 is provided with the terminal board 20 that makes a connection between the motor terminals 18a to 18c and power supply terminals (second connection terminals) 34a to 34c. The motor terminals 18a to 18c include a U-phase terminal, a V-phase terminal, and a W-phase terminal. The power supply terminals 34a to 34c are connected to a power control unit (power distribution unit (PDU)) that controls the amount of power supply from the power supply (not shown) to the rotating electrical machine 10.

As illustrated in FIGS. 2 to 5, the terminal board 20 includes a body 36 mounted inside the motor case 22, bus rods (relay conductors) 38 inserted and held in the body 36, and collars 40 disposed coaxially with the respective bus rods 38. For example, the body 36 is made of a resin material, which is a non-conductive material. The body 36 includes a base portion 44, a first retainer 46, and a second retainer 48. The base portion 44 is secured to the motor case 22 by inserting a pair of fastening bolts 42 into a pair of collars (not shown) inserted in the body 36. The first retainer 46 protrudes from one side of the base portion 44 (in the direction of arrow A) and has the three-phase motor terminals 18a to 18c inserted therein. The second retainer 48 protrudes from the other side of the base portion 44 (in the direction of arrow B) and holds the bus rods 38.

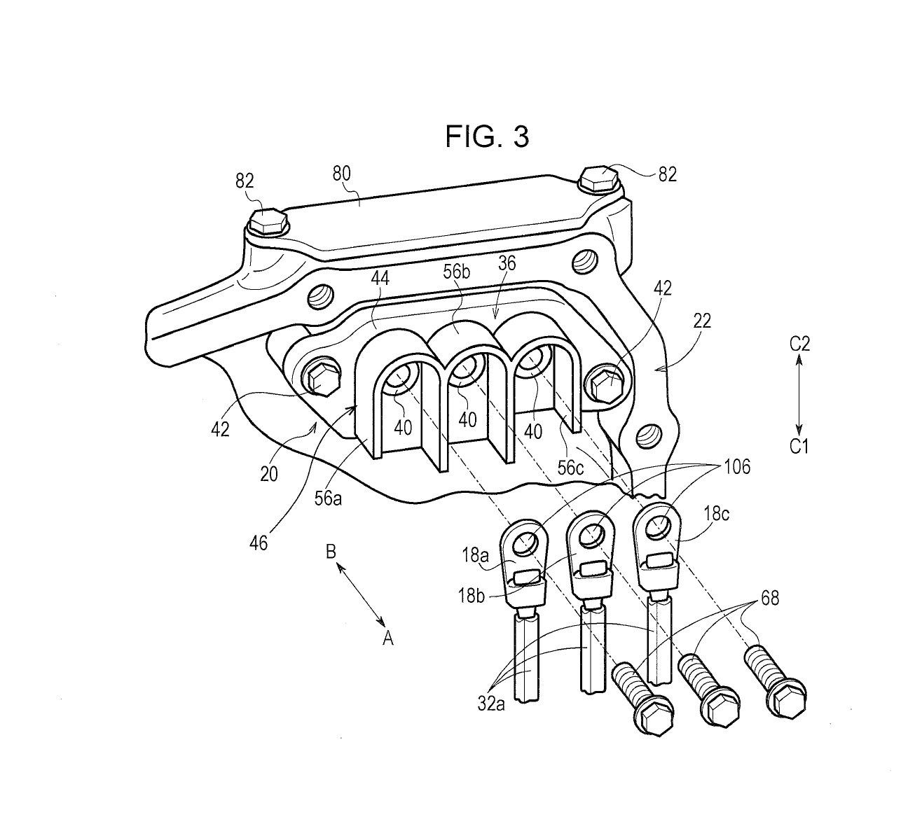

As illustrated in FIG. 3, the base portion 44 is substantially in the shape of a rectangle having a predetermined width. The pair of fastening bolts 42 is inserted into holes at both ends of the base portion 44 in the width direction. The fastening bolts 42 are screwed into respective screw holes (not shown), with the base portion 44 being in contact with a first mounting surface 50 (see FIG. 2) formed in an inner wall surface of the motor case 22. This allows the terminal board 20 to be secured, at the base portion 44, to the interior of the motor case 22. As illustrated in FIG. 2, the terminal board 20 is secured in place such that the first retainer 46 faces toward one end of the motor case 22 (in the direction of arrow A) to which the motor case cover 26 is attached, and that the second retainer 48 faces toward the transmission case 28 (in the direction of arrow B).

An end face of the base portion 44 is provided with a first seal ring 52 mounted in an annular groove facing the motor case 22. When the body 36 is assembled in the motor case 22, the first seal ring 52 is in contact with the inner wall surface of the motor case 22. This prevents lubricating oil (e.g., automatic transmission fluid (ATF) for cooling the rotating electrical machine 10) in the motor case 22 from entering a storage hole formed between the first mounting surface 50 and a second mounting surface 96 of the motor case 22.

The base portion 44 is provided with through holes 54 extending from the first retainer 46 to the second retainer 48. The collars 40 having a cylindrical shape are coaxially disposed inside the respective through holes 54. For example, the collars 40 are made of a metal material, which is a conductive material, and are integrally formed by insert molding in the through holes 54.

As illustrated in FIG. 3, the first retainer 46 has three first protective walls 56a to 56c arranged side by side across the width of the base portion 44. The first protective walls 56a to 56c stand on the base portion 44 and are U-shaped in cross section. The first protective walls 56a to 56c are provided as many as the number of the three-phase motor terminals 18a to 18c. The first protective walls 56a to 56c are positioned such that they are open in the direction orthogonal to the width of the base portion 44, and that the open portions are adjacent to the stator 12 (see FIG. 1). The through holes 54 are formed in the respective centers of the first protective walls 56a to 56c (see FIG. 2). The motor terminals 18a to 18c are inserted into the respective first protective walls 56a to 56c which divide the first retainer 46. Cables 32a connected to the respective motor terminals 18a to 18c are led out downward (in the direction of arrow C1) through the open portions of the first protective walls 56a to 56c.

The first protective walls 56a to 56c are provided as division walls that prevent a short circuit caused by contact between the adjacent motor terminals 18a to 18c.

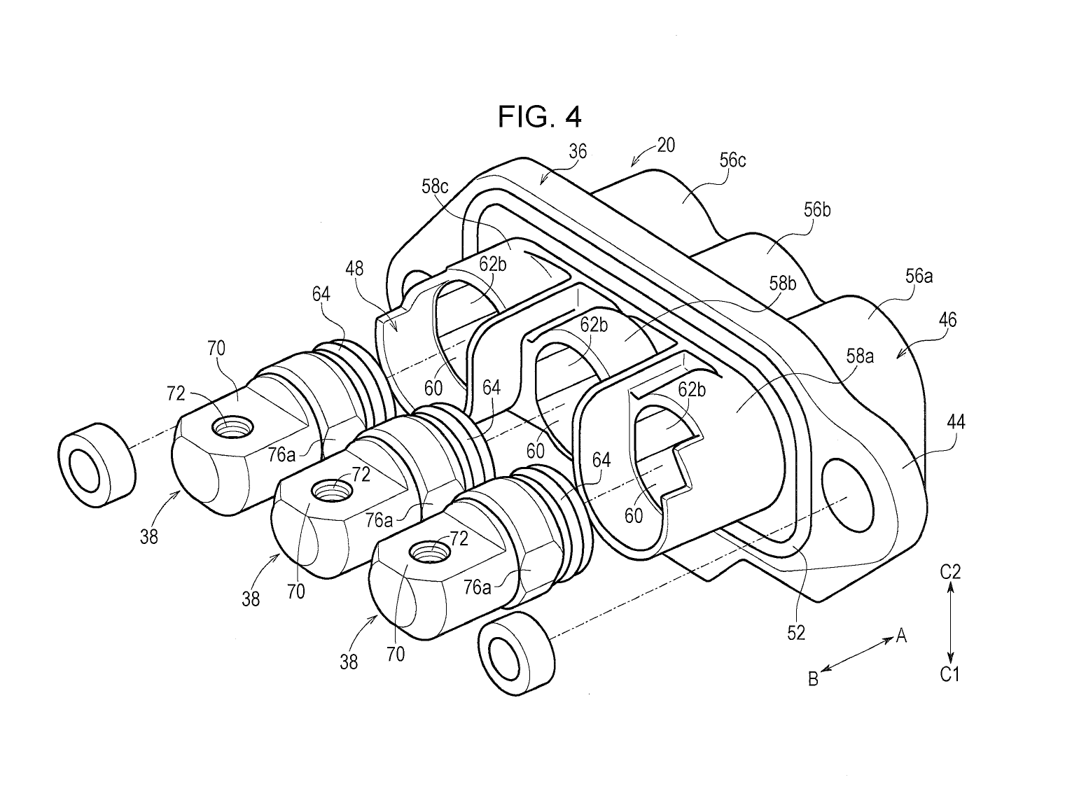

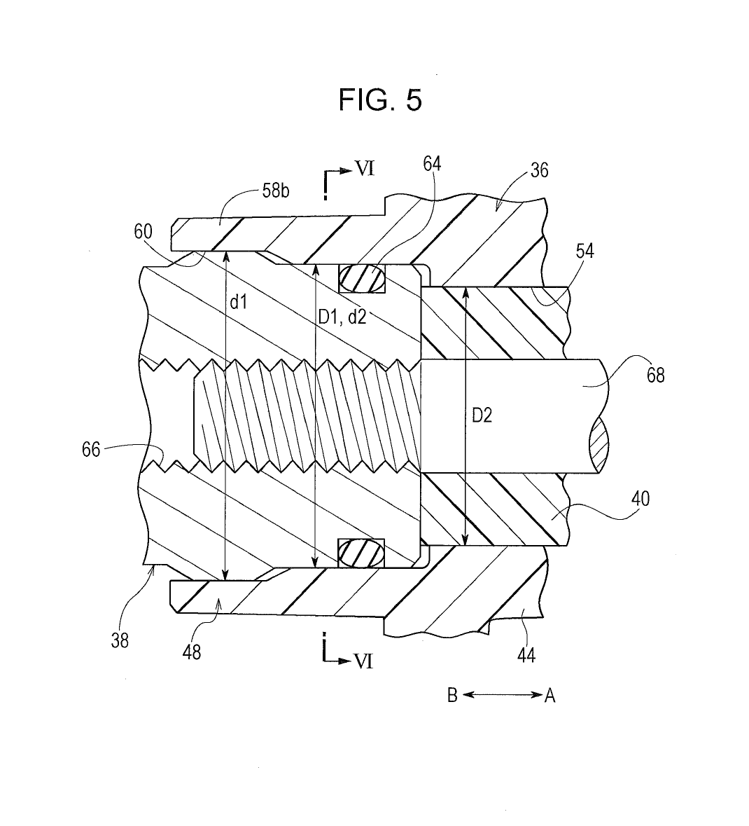

As illustrated in FIG. 4, and similar to the first retainer 46, the second retainer 48 has three second protective walls 58a to 58c arranged side by side across the width of the base portion 44. The second protective walls 58a to 58c cylindrically protrude by a predetermined distance from the base portion 44, and are internally provided with respective insertion holes 60 for insertion of the bus rods 38. The insertion holes 60 are coaxial with, and communicate with, the respective through holes 54. As illustrated in FIG. 5, a diameter D1 of each insertion hole 60 is greater than a diameter D2 of the corresponding through hole 54 (D1>D2). The second protective walls 58a to 58c are provided for the purpose of preventing a short circuit caused by contact between the adjacent power supply terminals 34a to 34c.

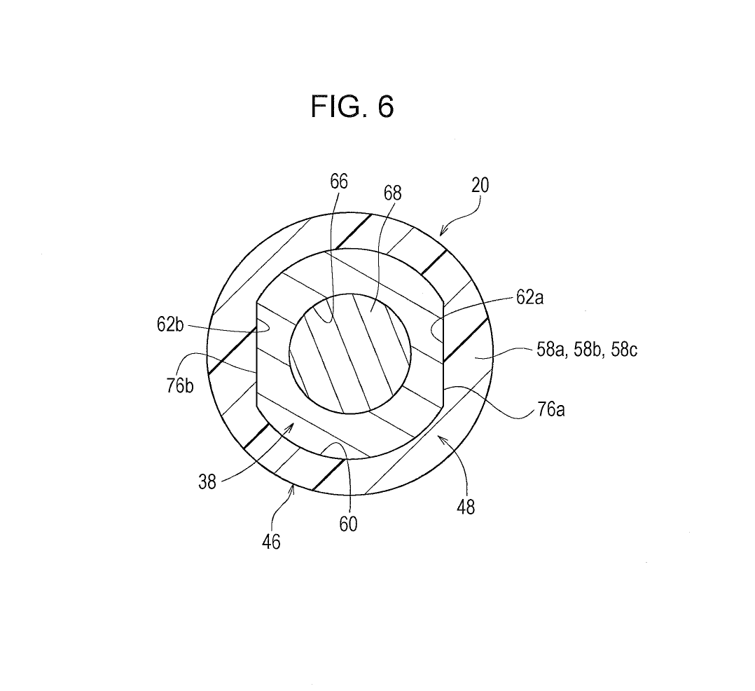

As illustrated in FIGS. 4 and 6, the inner surface of each of the insertion holes 60 is provided with a pair of planar flat portions 62a and 62b substantially parallel to the axis of the insertion hole 60 (i.e., substantially parallel to the direction of arrows A and B). For example, the flat portions 62a and 62b are formed to be symmetric with respect to the axis of the insertion hole 60.

As illustrated in FIGS. 2 and 4, the bus rods 38 are shaft-like members made of a conductive material, such as a metal material. One ends of the bus rods 38 are inserted into the respective insertion holes 60 of the second retainer 48 and held in the body 36, whereas the other ends of the bus rods 38 protrude from the second retainer 48 and connect to the respective power supply terminals 34a to 34c of cables 32b connected to the power control unit (not shown). That is, three bus rods 38 are provided in accordance with the number of the second protective walls 58a to 58c of the second retainer 48.

One end of each of the bus rods 38 is provided with a rod seal 64 mounted in an annular groove in the outer surface of the bus rod 38. The rod seal 64 is in contact with the inner surface of the corresponding insertion hole 60. This prevents entry of lubricating oil through a space between the bus rod 38 and the second retainer 48 having the insertion hole 60.

Also, the one end of each of the bus rods 38 is provided with a first bolt hole 66 extending toward the other end of the bus rod 38 (in the direction of arrow B). The first bolt hole 66 has a predetermined length in the axial direction (in the direction of arrow B), and is coaxial with the corresponding collar 40. First terminal bolts 68 for fastening the motor terminals 18a to 18c to the first retainer 46 of the terminal board 20 are screwed through the collars 40 into the respective first bolt holes 66.

The other end of each of the bus rods 38 has a terminal mounting portion 70 which is a planar portion formed by cutting the bus rod 38 along the axis (in the direction of arrows A and B). The power supply terminals 34a to 34c are connected to the respective terminal mounting portions 70. The terminal mounting portions 70 are provided with respective second bolt holes 72 passing through the bus rods 38 in the direction orthogonal to the axes of the bus rods 38 (in the direction of arrow C1). Second terminal bolts 74 (described below) are screwed into the respective second bolt holes 72. The bus rods 38 are positioned to allow the second bolt holes 72 to face in the upward direction in the motor case 22 (in the direction of arrow C2).

That is, in the bus rods 38, the first bolt holes 66 to which the motor terminals 18a to 18c are connected and the second bolt holes 72 to which the power supply terminals 34a to 34c are connected are orthogonal to each other.

Additionally, as illustrated in FIGS. 4 and 6, each of the bus rods 38 has a pair of planar portions 76a and 76b in the outer surface between the one and other ends thereof. The planar portions 76a and 76b are substantially parallel to the axis of the bus rod 38 (i.e., substantially parallel to the direction of arrows A and B). For example, the planar portions 76a and 76b are formed to be symmetric with respect to the axis of the bus rod 38. As illustrated in FIG. 6, when the bus rod 38 is inserted into the corresponding insertion hole 60 of the second retainer 48, the planar portions 76a and 76b come into contact and engage with the flat portions 62a and 62b, respectively, of the insertion hole 60. This regulates the rotational displacement of the bus rod 38 in the insertion hole 60.

That is, the planar portions 76a and 76b of the bus rod 38 and the flat portions 62a and 62b of the insertion hole 60 engage with each other to serve as a rotation stopper that regulates the rotational displacement of the bus rod 38 with respect to the body 36 having the insertion hole 60.

As illustrated in FIG. 5, a diameter d1 of one portion of each bus rod 38 is greater than a diameter d2 of another portion of the bus rod 38 (d1>d2).

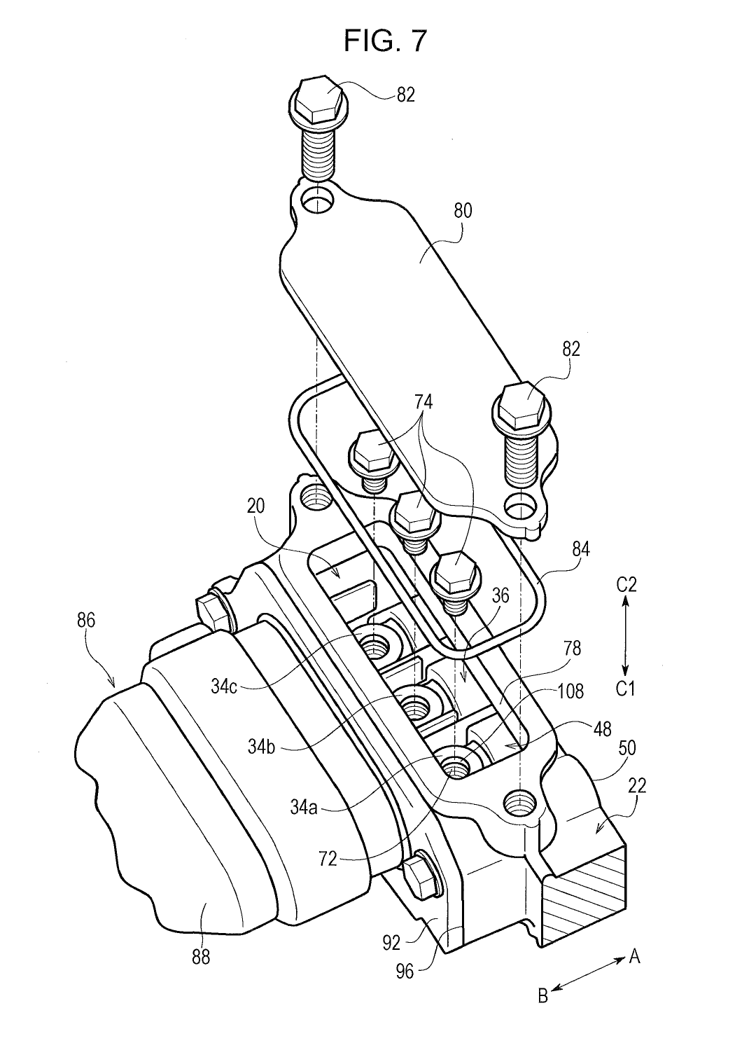

As illustrated in FIGS. 2 and 7, the outer surface of the motor case 22 is provided with a work opening (opening) 78 that faces the other ends of the bus rods 38 of the terminal board 20. The work opening 78 has a size that allows the three bus rods 38 arranged side by side to be viewed from outside the motor case 22. The work opening 78 opens in a substantially rectangular shape that allows communication between the inside and the outside of the motor case 22. A substantially rectangular terminal cover 80 corresponding to the work opening 78 is mounted over the work opening 78. The terminal cover 80 is secured to the motor case 22 by screwing fixing bolts 82 inserted in respective holes at both ends of the terminal cover 80 in the width direction. The work opening 78 is thus closed.

An end face of the terminal cover 80 facing the Motor case 22 (in the direction of arrow C1) is provided with a second seal ring 84 mounted in an annular groove. When the terminal cover 80 closes the work opening 78, the second seal ring 84 comes into contact with the motor case 22. This prevents entry of water from the outside through a space between the motor case 22 and the terminal cover 80.

A power supply connection portion 86 has the power supply terminals 34a to 34c connected to respective ends of the cables 32b connected to the power control unit (not shown). The power supply terminals 34a to 34c and the cables 32b are partially covered with a waterproof cover 88 made of, for example, a resin material. A socket 90 is integrally mounted on an end portion of the waterproof cover 88.

The cables 32b are connected by fusing or the like to respective one ends of the power supply terminals 34a to 34c. The other ends of the power supply terminals 34a to 34c have a plate-like shape and are provided with respective terminal holes 108. With the other ends of the power supply terminals 34a to 34c placed on the respective terminal mounting portions 70 of the bus rods 38, the second terminal bolts 74 are screwed through the respective terminal holes 108 into the second bolt holes 72 of the bus rods 38. This allows the power supply terminals 34a to 34c to be connected to the respective other ends of the bus rods 38.

With the power supply terminals 34a to 34c fastened to the respective bus rods 38, a flange 92 at an end of the socket 90 comes into contact with the second mounting surface 96 of the motor case 22. This allows a first seal member 94 mounted in an annular groove in an end face of the flange 92 to be in contact with the second mounting surface 96. Thus, it is possible to prevent entry of water from the outside through a space between the flange 92 and the second mounting surface 96.

The socket 90 is internally provided with a cylindrical holder 98 and a guide body 100 connected to an end of the holder 98. The holder 98 and the guide body 100 are configured to hold the power supply terminals 34a to 34c. The boundary between the holder 98 and the guide body 100 is internally provided with an annular second seal member 102. Since the second seal member 102 is in contact with the outer surfaces of the power supply terminals 34a to 34c, it is possible to prevent entry of moisture through a space between the holder 98 and the power supply terminals 34a to 34c toward the bus rods 38.

Additionally, a third seal member 104 is mounted in an annular groove in the outer surface of the holder 98. Since the third seal member 104 is in contact with the inner surface of the socket 90, it is possible to prevent entry of water through a space between the holder 98 and the socket 90.

When the power supply connection portion 86 is assembled to the motor case 22, the holder 98 is partially inserted into the motor case 22 and the inserted end portion of the holder 98 engages with the second retainer 48 of the body 36.

The rotating electrical machine 10 according to an embodiment of the present disclosure is basically configured as described above. A description will now be given of a connection of the motor terminals 18a to 18c to the terminal board 20 and a connection of the power supply terminals 34a to 34c to the terminal board 20.

First, a connection of the motor terminals 18a to 18c to the terminal board 20 will be described. As illustrated in FIG. 3, the motor terminals 18a to 18c are arranged with respect to the first retainer 46, with the body 36 of the terminal board 20 mounted in advance on the first mounting surface 50 of the motor case 22 with the fastening bolts 42. The motor terminals 18a to 18c are positioned to allow the cables 32a to extend downward from the open portions of the first retainer 46 toward the stator 12.

The motor terminals 18a to 18c are arranged such that their terminal holes 106 are coaxial with the respective collars 40 exposed toward the first retainer 46 (in the direction of arrow A). Then, the first terminal bolts 68 are screwed, through the terminal holes 106 and the collars 40, into the respective first bolt holes 66 of the bus rods 38. The motor terminals 18a to 18c are thus connected to the respective bus rods 38 while being in contact with the respective end faces of the collars 40 in the first retainer 46 of the terminal board 20. The motor terminals 18a to 18c, which are connected to the bus rods 38 through the first terminal bolts 68 made of a conductive material, are electrically connected to the bus rods 38.

To connect the motor terminals 18a to 18c to the bus rods 38, the first terminal bolts 68 are screwed into the first bolt holes 66. Under the screwing action of the first terminal bolts 68, the bus rods 38 are pulled toward the motor terminals 18a to 18c (in the direction of arrow A in FIG. 2) and axially moved along the insertion holes 60 of the second retainer 48 (in the direction of arrow A in FIG. 2). As described above, the planar portions 76a and 76b of each of the bus rods 38 engage with the corresponding flat portions 62a and 62b of the second retainer 48. This prevents rotation of the bus rods 38 and allows the bus rods 38 to move only in the axial direction (in the direction of arrow A).

When one ends of the bus rods 38 come into contact with the respective ends of the collars 40, the axial movement of the bus rods 38 toward the motor terminals 18a to 18c (in the direction of arrow A) is regulated, so that the bus rods 38 are held and secured inside the respective insertion holes 60. That is, the first terminal bolts 68 allow not only the motor terminals 18a to 18c to be fastened to the first retainer 46, but also allow the bus rods 38 inserted in the first retainer 46 to be held and secured inside the insertion holes 60.

Next, a description will be given of a connection of the power supply terminals 34a to 34c to the terminal board 20 to which the motor terminals 18a to 18c are connected. When the motor terminals 18a to 18c and the power supply terminals 34a to 34c are connected to the terminal board 20, the bus rods 38 are secured to the body 36 together with the motor terminals 18a to 18c as described above. Therefore, to secure the bus rods 38 to the body 36, it may be necessary to connect the motor terminals 18a to 18c to the terminal board 20 before connecting the power supply terminals 34a to 34c to the terminal board 20.

First, as illustrated in FIG. 7, the terminal cover 80 mounted on the motor case 22 is removed by removing the fixing bolts 82 that secure the terminal cover 80. The work opening 78 is thus opened. This allows the second retainer 48 of the body 36 and the terminal mounting portions 70 of the bus rods 38 to be viewed through the work opening 78 from outside the motor case 22.

Next, the power supply connection portion 86 is moved from the direction of the second mounting surface 96 of the motor case 22 (i.e., from the direction of arrow B) to insert the power supply terminals 34a to 34c into the motor case 22. At the same time, the flange 92 of the socket 90 in contact with the second mounting surface 96 is secured to the motor case 22 with bolts.

Next, the power supply terminals 34a to 34c are placed on the respective terminal mounting portions 70 of the bus rods 38 such that the second bolt holes 72 coincide with the respective terminal holes 108. Then, the second terminal bolts 74 are inserted from above the power supply terminals 34a to 34c through the work opening 78, and screwed through the terminal holes 108 into the respective second bolt holes 72. Thus, as illustrated in FIG. 2, the second terminal bolts 74 allow the power supply terminals 34a to 34c to be connected to the respective terminal mounting portions 70 of the bus rods 38.

Finally, after the terminal cover 80 is placed over the work opening 78 of the motor case 22 again, the terminal cover 80 is secured with the fixing bolts 82 to close the work opening 78. Thus, the process of connecting the power supply terminals 34a to 34c to the terminal board 20 including the bus rods 38 is completed.

Thus, power supplied from the power supply through the power control unit (PDU) to the power supply terminals 34a to 34c is further supplied through the bus rods 38 of the terminal board 20 to the three-phase motor terminals 18a to 18c, from which the power is supplied to the coils 30.

As described above, in the rotating electrical machine 10 of the present embodiment, the terminal board 20 makes a connection between the motor terminals 18a to 18c including the U-phase terminal, the V-phase terminal, and the W-phase terminal, and the power supply terminals 34a to 34c connected to the power supply (not shown). The terminal board 20 includes the body 36 secured to the motor case 22. The motor terminals 18a to 18c and the power supply terminals 34a to 34c are connected to the bus rods 38 inserted in the second retainer 48 of the body 36. When the motor terminals 18a to 18c are fastened through the collars 40 to the respective one ends of the bus rods 38 (facing in the direction of arrow A), the first terminal bolts 68 are screwed into the respective first bolt holes 66 of the bus rods 38. This brings the bus rods 38 close to the motor terminals 18a to 18c along the insertion holes 60 of the second retainer 48 (in the direction of arrow A), so that the bus rods 38 can be secured inside the respective insertion holes 60. Therefore, the number of components of the terminal board 20 and thus the number of assembly man-hours can be smaller than those in the related art where, for example, a cover is used to secure busbars to the terminal board.

That is, since the first terminal bolts 68 for fastening the motor terminals 18a to 18c can be used to secure the bus rods 38 to the second retainer 48 of the body 36, it is possible to reduce the number of components and the number of assembly man-hours.

When the motor case cover 26 mounted on the motor case 22 is removed, the first retainer 46 of the terminal board 20 can be exposed toward the opening. This allows the motor terminals 18a to 18c to be easily and reliably connected to the first retainer 46. Also, when the terminal cover 80 for the work opening 78 in the outer surface of the motor case 22 is removed, the power supply terminals 34a to 34c can be easily and reliably connected, with the second terminal bolts 74, to the respective terminal mounting portions 70 of the bus rods 38. Therefore, in the rotating electrical machine 10, it is possible to simplify the process of connecting the motor terminals 18a to 18c and the power supply terminals 34a to 34c to the terminal board 20, and reduce the number of assembly man-hours.

As described above, a rotation stopper (formed by the planar portions 76a and 76b and the flat portions 62a and 62b) is provided between each bus rod 38 and the second retainer 48 in which the bus rod 38 is inserted. Therefore, when the motor terminals 18a to 18c are connected to the respective bus rods 38, it is possible to prevent erroneous rotational displacement of the bus rods 38 caused by screwing of the first terminal bolts 68, and allow the second terminal bolts 74 for connecting the power supply terminals 34a to 34c to the bus rods 38 to always face the work opening 78.

In other words, if the bus rods 38 are not provided with the rotation stoppers, the bus rods 38 may rotate when the motor terminals 18a to 18c are connected to the bus rods 38. As a result, the second bolt holes 72 and the terminal mounting portions 70 may not be visible from the work opening 78. This may interfere with the process of connecting the power supply terminals 34a to 34c to the terminal mounting portions 70.

As illustrated in FIG. 5, the diameter D1 of the bus rods 38 is greater than the diameter D2 of the collars 40 (D1>D2). In this case, burrs produced when the collars 40 are formed by insert molding in the through holes 54 of the body 36 can be suitably accommodated in spaces, each of which is defined by an outer surface of an end of each collar 40 and one end of the corresponding bus rod 38. Therefore, even if burrs occur in the insertion holes 60, the burrs can be prevented from flowing toward the collars 40 (in the direction of arrow A) or between the collars 40 and the bus rods 38.

As described above, the collars 40 are disposed between the motor terminals 18a to 18c and the bus rods 38. Even if an axial force is applied in the axial direction (in the direction of arrow A) to the bus rods 38 under the screwing action of the first terminal bolts 68, the axial force can be appropriately shared with the collars 40 when one ends of the bus rods 38 come into contact with the corresponding ends of the collars 40. Therefore, a load on the body 36 can be smaller than that in the configuration where, for example, the collars 40 are not provided and an axial force is directly applied to the body 36. Thus, the durability of the body 36 can be improved without having to design the body 36 with an extremely high strength. Therefore, it is possible not only to reduce the cost of manufacture, but also to provide lighter products.

As described above, each of the bus rods 38 is provided with the rod seal 64 mounted in the outer surface thereof. The rod seal 64 is positioned at one end portion of the bus rod 38 facing in the direction of arrow A, having an outside diameter (indicated by d2 in FIG. 5) smaller than that of another portion (indicated by d1 in FIG. 5), and not provided with the planar portions 76a and 76b serving as a rotation stopper. Therefore, the rod seal 64 can be formed into an annular shape, and does not need to be shaped into an odd shape to fit the cross-sectional shape of the planar portions 76a and 76b. It is thus possible to reduce the cost of manufacturing the rod seals 64. Also, the rod seals 64 can be reliably in contact with the respective insertion holes 60 for sealing.

The rotating electrical machine according to the present disclosure is not limited to the embodiments described above, and may be configured in various ways without departing from the scope of the present disclosure.

A rotating electrical machine according to the embodiment includes a stator having a conductor line wound thereon, a housing configured to contain the stator, and a terminal board configured to make an electrical connection between the conductor line and an external power line disposed outside the housing and connected to a power supply. The terminal board includes a body and a relay conductor to which a first connection terminal and a second connection terminal are connected. The first connection terminal is inserted in the body and connected to the conductor line, and the second connection terminal is connected to the external power line. The first connection terminal is connected to the relay conductor with a fastening member screwed into an end portion of the relay conductor, which is moved toward the first connection terminal and held in the body under the screwing action of the fastening member.

In the embodiment, as described above, the terminal board includes the relay conductor to which the first connection terminal connected to the conductor line and the second connection terminal connected to the external power line are connected. In the terminal board, the first connection terminal is connected to the relay conductor by screwing the fastening member into the end portion of the relay conductor. The relay conductor is held in the body by moving it toward the first connection terminal under the screwing action of the fastening member.

That is, unlike the related art which uses a cover to secure the busbars to the terminal board, the relay conductor can be secured in place using the same fastening member that is used to connect the first connection terminal to the relay conductor. Therefore, it is possible to reduce the number of components of the terminal board, and thus to reduce the number of assembly man-hours.

A case containing the terminal board may have an opening that opens to face the second connection terminal, and a cover member may be removably attached to the opening. To connect the second connection terminal to the relay conductor, the cover member can be removed to allow the connecting process to be performed through the opening. This not only eases the connecting process, but also reduces the number of assembly man-hours.

The relay conductor may be provided with a rotation stopper that regulates rotational displacement of the relay conductor with respect to the body, and a seal member may be provided on a side of the rotation stopper adjacent to the first connection terminal. Thus, unlike the case in which the seal member is provided in the rotation stopper, the seal member does not need to be shaped into an odd shape to fit the shape of the rotation stopper. Therefore, it is possible not only to reduce the cost of manufacturing the seal member, but also to provide reliable sealing.

A collar in contact with the end portion of the relay conductor may be provided between the relay conductor and the first connection terminal. Thus, when the relay conductor is moved toward the body under the screwing action of the fastening member, a pressure applied from the relay conductor can be shared with the collar. Therefore, as compared to the case where the pressure is directly applied to the body, the durability of the body can be improved. Also, since the body does not need to have an extremely high strength, it is possible to reduce the manufacturing cost and the product weight.

An outside diameter of the collar may be smaller than an outside diameter of the relay conductor. Thus, a burr produced near an end portion of the collar when the collar is formed by insert molding in the body can be accommodated in a space defined by the end portion of the relay conductor and the collar. Therefore, it is possible to prevent the burr from flowing between the collar and the relay conductor.

The first connection terminal and the second connection terminal may be connected to the relay conductor such that the first connection terminal and the second connection terminal are orthogonal to each other.

Obviously, numerous modifications and variations of the present invention are possible in light of the above teachings. It is therefore to be understood that within the scope of the appended claims, the invention may be practiced otherwise than as specifically described herein.

What is claimed is:

1. A rotating electrical machine comprising:
a stator having a conductor line wound thereon;
a housing to contain the stator;
a first connection terminal connected to the conductor line;
a terminal board to make an electrical connection between the conductor line and an external power line which is disposed outside the housing and which is connected to a power supply, the terminal board including a body and a relay conductor to which the first connection terminal and a second connection terminal are connected, the relay conductor being provided in the body, the second connection terminal being connected to the external power line; and
a fastening member with which the first connection terminal is connected to the relay conductor and which is screwed into an end portion of the relay conductor, the relay conductor being provided, under screwing action of the fastening member, to be moved toward the first connection terminal to be held in the body.

2. The rotating electrical machine according to claim 1, further comprising:
a case containing the terminal board and having an opening that opens to face the second connection terminal; and
a cover member removably attached to the opening.

3. The rotating electrical machine according to claim 1, further comprising:
a seal member,
wherein the relay conductor includes a rotation stopper to regulate rotational displacement of the relay conductor with respect to the body, and
wherein the seal member is provided on a side of the rotation stopper adjacent to the first connection terminal.

4. The rotating electrical machine according to claim 1, further comprising:
a collar in contact with the end portion of the relay conductor and provided between the relay conductor and the first connection terminal.

5. The rotating electrical machine according to claim 4, wherein an outside diameter of the collar is smaller than an outside diameter of the relay conductor.

6. The rotating electrical machine according to claim 5, wherein the body includes
an insertion hole in which the relay conductor is provided, and
a through hole in which the collar is provided.

7. The rotating electrical machine according to claim 6, wherein an inner diameter of the insertion hole is greater than an inner diameter of the through hole.

8. The rotating electrical machine according to claim 1, wherein the first connection terminal and the second connection terminal are connected to the relay conductor such that the first connection terminal and the second connection terminal are orthogonal to each other.
